(19) United States
(12) Patent Application Publication
(10) Pub. No.: US 2026/0064564 A1
(43) Pub. Date: Mar. 5, 2026

(54) MONITORING CPU CYCLES FOR ASYNCHRONOUS PROCESSES IN A MEMORY SUB-SYSTEM

(71) Applicant: Micron Technology, Inc., Boise, ID (US)

(72) Inventors: Sai Sindhuja Thirumala Aravamudan, San Jose, CA (US); Andrei Konan, Meridian, ID (US)

(21) Appl. No.: 18/818,550

(22) Filed: Aug. 28, 2024

(51) Int. Cl. G06F 11/36; G06F 11/34

(52) U.S. Cl. CPC G06F 11/3612; G06F 11/3466

(57) ABSTRACT

A processing device in a memory sub-system initiates execution of an instance of a process on a memory device, associates a unique tag with the instance of the process, and stores an indication of a start time value for the instance of the process in an entry of a tag repository corresponding to the unique tag. Upon detecting a completion of the instance of the process, the processing device stores an indication of a stop time value for the instance of the process in the entry of the tag repository corresponding to the unique tag.

### TECHNICAL FIELD

Embodiments of the disclosure relate generally to memory sub-systems, and more specifically, relate to monitoring CPU cycles for asynchronous processes in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating a memory sub-system controller configured to monitor CPU cycles for asynchronous processes in accordance with some embodiments of the present disclosure.

FIG. 3 is a flow diagram of an example method of monitoring CPU cycles for asynchronous processes in a memory sub-system in accordance with some embodiments of the present disclosure.

FIG. 4 is a block diagram illustrating a process instance tag repository for monitoring CPU cycles of asynchronous processes in accordance with some embodiments of the present disclosure.

FIG. 5 is a block diagram of an example computer system in which embodiments of the present disclosure may operate.

### DETAILED DESCRIPTION

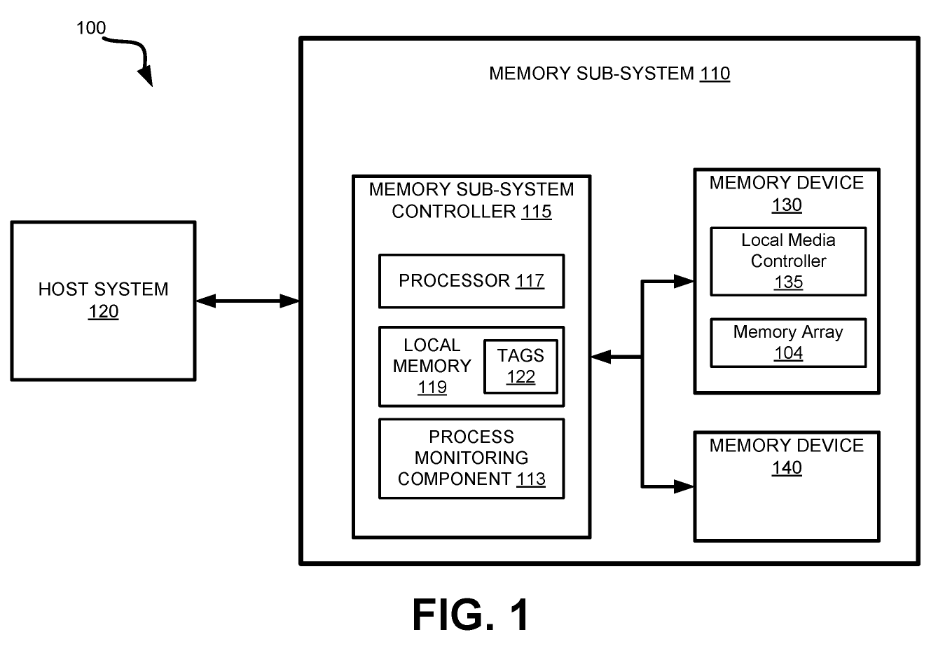

Aspects of the present disclosure are directed to monitoring CPU cycles for asynchronous processes in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

One example of a memory sub-system is a solid-state drive (SSD) that includes one or more non-volatile memory devices and a memory sub-system controller to manage the non-volatile memory devices. The memory devices can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

The memory sub-system controller can be programmed with code (i.e., firmware) that enables the performance of a variety of different memory access operations, such as program operations, read operations, etc. During the development process for the memory sub-system, it can be advantageous to monitor the execution of such operations so that improvements or optimizations can be made. For example, tracking the amount of time that a given piece of code takes to execute a particular type of memory access operation can be beneficial. In some cases, this amount of time can be measured using a number of processing cycles executed by a processing device (e.g., CPU) in the memory sub-system controller. Although there can be many different types of memory access operations or memory sub-system controller processes, each individual type may be identified using a separate unique identifier (ID).

If processes or operations are executed synchronously, tracking the process execution time is relatively straightforward. For example, some processes with given ID may not permit parallel operations, such that when one instance of the process is started, another instance cannot be started until the initial instance has ended. Thus, processing logic in the memory sub-system controller can record a timestamp or cycle count when the instance is started and another when the instance ends, and calculate the difference between the values to determine the total execution time for that instance. If, however, other processes or operations are executed asynchronously, tracking the process execution time becomes more complex. Many processes, for example, can have many instances operating in parallel (e.g., on different processing devices or on the same processing device using time slicing). In these cases, when one instance of the process is started, another instance can be started before the initial instance has ended. Similarly, the second instance may end before the first instance ends. If only the ID is used to track the processes or operations, the processing logic may not be able to accurately determine the respective execution times, which may give a misleading impression with respect to the overall process execution measurements of the memory sub-system.

Aspects of the present disclosure address the above and other deficiencies by implementing a process instance tagging solution to monitor CPU cycles for asynchronous processes in a memory sub-system. In one embodiment, processing logic in the memory sub-system controller maintains a set of tags for memory access operations or processes executed by the memory sub-system controller. Depending on the implementation, there can be a separate set of tags for each process ID or the same set of tags can be shared by multiple process IDs. When a new instance of a given process ID is started, the processing logic can assign a tag to the instance from the set of tags and record a start value (e.g., a timestamp or cycle count) in a tag repository entry associated with the assigned tag. The same process can be performed for any additional instances of the process ID that are initiated. When any instance of the process ID completes execution, the processing logic can identify the tag of instance and record a stop value in the corresponding tag repository entry. By determining the difference between the start value and the stop value, the processing logic can calculate the total execution time for that instance. The same can be done when any other instance of the process ID completes. With the processing time of each instance easily determined, the processing logic can calculate any relevant statistics including average, median, maximum, minimum, etc., for the given process ID. This information can be exported from the memory sub-system (e.g., using a debug interface) for further analysis and can be used to improve overall performance of the memory sub-system.

Advantages of the approach described herein include, but are not limited to, improved monitoring of memory access operations or memory sub-system controller processes in the memory sub-system. The tagging solution allows for accurate collection of CPU cycle data for individual instances of asynchronous processes, without confusion stemming from the processes starting and stopping out of order. The data can be used to identify performance bottlenecks in various firmware processing flows and allow developers to optimize such flow across various workloads.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface provides an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a process monitoring component 113 that implements a process instance tagging solution to monitor CPU cycles (e.g., of processor 117) for asynchronous processes in memory sub-system 110. In one embodiment, process monitoring component 113 maintains a set of tags 122 (e.g., in local memory 119) for memory access operations or processes executed by the memory sub-system controller 115. When a new instance of a given process ID is started, process monitoring component 113 can assign a tag to the instance from the set of tags 122 and record a start value (e.g., a timestamp or cycle count) in a tag repository entry associated with the assigned tag. The same process can be performed for any additional instances of the process ID that are initiated. When any instance of the process ID completes execution, process monitoring component 113 can identify the tag of the instance and record a stop value in the corresponding tag repository entry. By determining the difference between the start value and the stop value, process monitoring component 113 can calculate the total execution time for that instance. Further details with regard to the operations of process monitoring component 113 are described below.

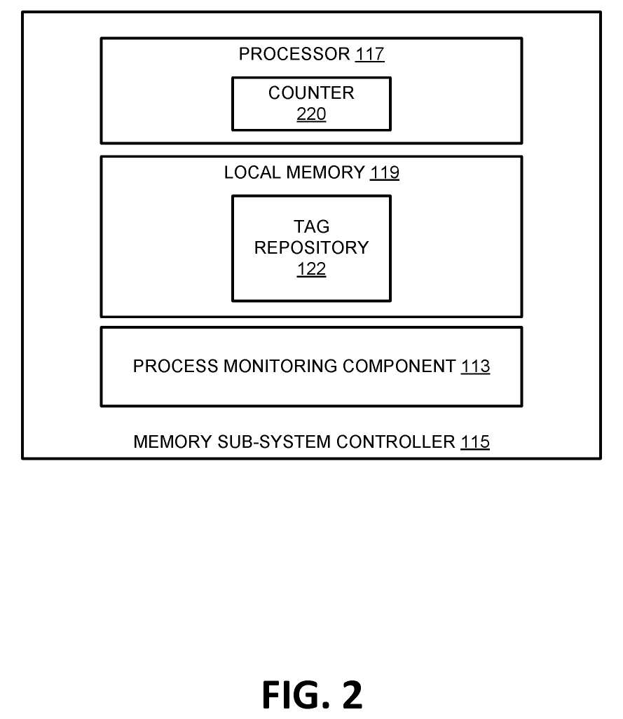

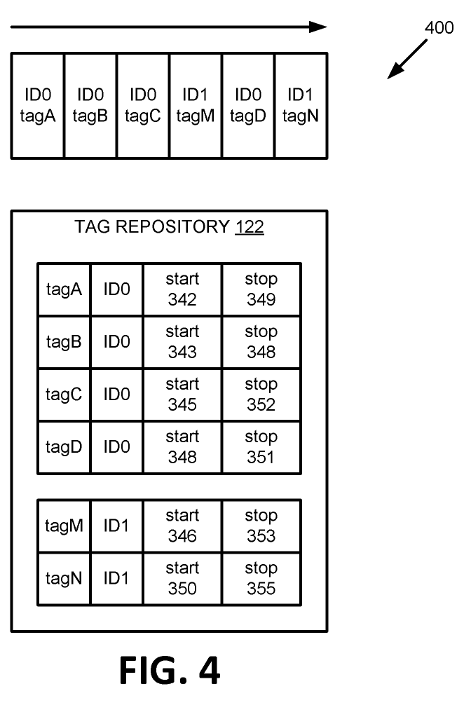

FIG. 2 is a block diagram illustrating a memory sub-system controller configured to monitor CPU cycles for asynchronous processes in accordance with some embodiments of the present disclosure. In one embodiment, memory sub-system controller 115 includes processor 117 (e.g., a central processing unit (CPU) or other processing device), local memory 119 (e.g., an embedded memory), and process monitoring component 113. In one embodiment, process monitoring component 113 maintains a set of tags in tag repository 122, which can be maintained in local memory 119, for example. The set of tags in tag repository 122 may correspond to memory access operations or other processes executed by the memory sub-system controller 115. When a new instance of a given process ID is started, process monitoring component 113 can assign a tag to the instance from the set of tags 122 and record a start value (e.g., a timestamp or cycle count) in a tag repository entry associated with the assigned tag. For example, in one embodiment, processor 117 includes counter 220 which increments with each processing cycle performed by processor 117. Thus, process monitoring component 113 can record the value of the counter 220 in the corresponding entry of tag repository 122, as shown in FIG. 4, for example. Similarly, when any instance of the process ID completes execution, process monitoring component 113 can identify the tag of the instance and record a stop value (i.e., the current value of counter 220) in the corresponding entry of tag repository 122. By determining the difference between the start value and the stop value, process monitoring component 113 can calculate the total execution time for that instance of the process ID.

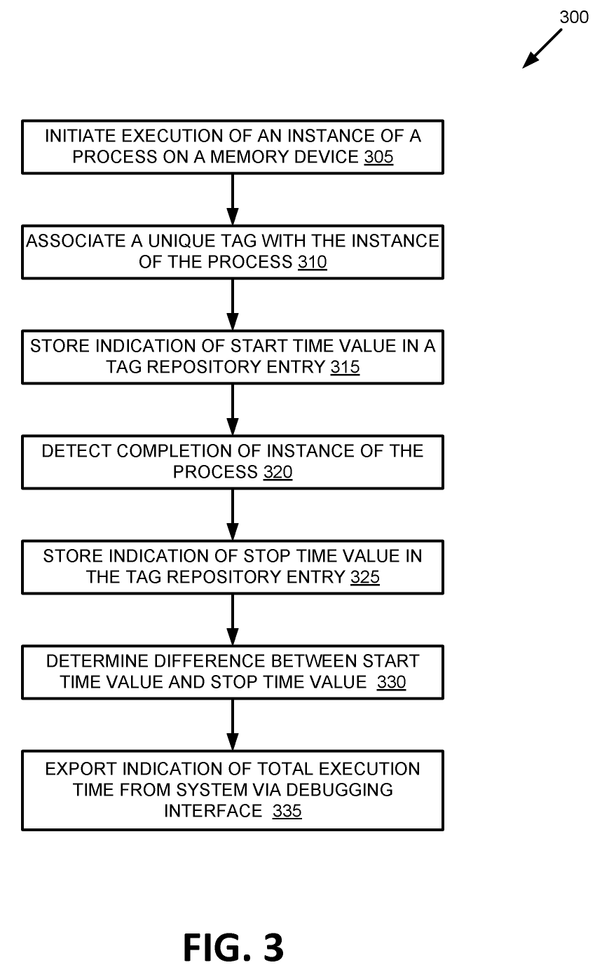

FIG. 3 is a flow diagram of an example method of monitoring CPU cycles for asynchronous processes in a memory sub-system in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by process monitoring component 113 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic (e.g., memory sub-system controller 115) initiates execution of an instance of a process on a memory device, such as memory device 130. In one embodiment, the process comprises at least one of a host-initiated memory access operation or an internally-initiated memory sub-system controller process. For example, the process may include a program operation, a read operation, or other similar operation. Although there can be many different types of memory access operations or memory sub-system controller processes, each individual type may be identified using a separate unique identifier (ID). In one embodiment, the process includes an asynchronous process where a plurality of instances of the process can be executed in parallel. For example, the multiple instances may be executed on different processing devices or on the same processing device using time slicing. In these cases, when one instance of the process is started, another instance can be started before the initial instance has ended. Similarly, the second instance may end before the first instance ends.

At operation 310, the processing logic (e.g., process monitoring component 113) associates a unique tag with the instance of the process. Although the process itself is identified by the unique ID, all instances of the same process will have the same unique ID. The unique tag, however, is a separate value that is unique to the individual instance of the process. Thus, each instance will have a different unique tag. In one embodiment, a set of tags for each process ID are available in tag repository 122. The number of tags in the set of tags can be based on how many instances of the process are permitted to be executed concurrently (i.e., at least partially overlapping in time). In another embodiment, multiple process IDs can share the same set of tags. In either embodiment, the process monitoring component 113 can select one of the available (i.e., unused) tags from the tag repository 122 and assign that tag to the instance of the process, as illustrated in FIG. 4.

FIG. 4 is a block diagram illustrating a process instance tag repository for monitoring CPU cycles of asynchronous processes in accordance with some embodiments of the present disclosure. A sequence of operations 400, can include a number of process instances corresponding to a number of different unique IDs (e.g., ID0, ID1). As described above, the process monitoring component 113 can associate a unique tag with each instance of the process. For example, the tag repository 122 may include respective entries for the different instances of the processes. To associate the unique tags, the process monitoring component can create new entries in the tag repository 122 corresponding to the initiated instances of the process, and store an indication of the unique tags (e.g., tagA, tagB, tagC, etc.) in the corresponding entries. For example, the first instance of process ID0 is assigned tagA, the second instance of process ID0 is assigned tagB, the third instance of process ID0 is assigned tagC, the first instance of process ID1 is assigned tagM, the fourth instance of process ID0 is assigned tagD, and the second instance of process ID1 is assigned tagN.

Referring again to FIG. 3, at operation 315, the processing logic stores an indication of a start time value for the instance of the process in an entry of the tag repository 122 corresponding to the unique tag. Using the first instance of process ID0 having been assigned tagA as an example, the process monitoring component 113 can store the indication of the start time value in the corresponding entry of the tag repository 122. In one embodiment, the start time value comprises a processing cycle count of the processing device 117, which is maintained by counter 220. In another embodiment, the start time value can be a timestamp from a local clock in memory sub-system 110 representing the time at which the first instance of process ID0 is initiated. As shown in FIG. 4, this start value can be “342” for example. The processing logic can similarly store the corresponding start time values for any additional process instances in the respective entries of tag repository 122. For example, multiple additional instances of a given process can be initiated (operation 310) and assigned corresponding tags (operations 310-315) before the first instance of the process completes execution (see operation 320 below). As shown in FIG. 4, the first instance of process ID0 is assigned tagA, the second instance of process ID0 is assigned tagB, and the third instance of process ID0 is assigned tagC. Each of the second and third instances of process ID0 are initiated before the first instance of process ID0 completes. The assigned tags can be stored in tag repository 122 and referenced upon the respective completions, as described in more detail below.

At operation 320, the processing logic detects a completion of the instance of the process. As the memory sub-system controller executes the instance of the process (e.g., to program data to the memory device 130 or read data from the memory device 130), the instance of the process will naturally reach completion. The process monitoring component 113 can monitor the operation of such process instances and detect which each instance reaches completion (e.g., by observing a corresponding entry in a completion queue, receiving a completion message from the memory device 130, etc.).

At operation 325, the processing logic stores an indication of a stop time value for the instance of the process in the entry of the tag repository corresponding to the unique tag. Continuing with the example of the first instance of process ID0 having been assigned tagA, the process monitoring component 113 can store the indication of the stop time value in the corresponding entry of the tag repository 122. In one embodiment, the stop time value comprises a processing cycle count of the processing device 117, which is maintained by counter 220. In another embodiment, the stop time value can be a timestamp from a local clock in memory sub-system 110 representing the time at which the first instance of process ID0 is complete. As shown in FIG. 4, this stop value can be “349” for example. The processing logic can similarly store the corresponding stop time values for any additional process instances in the respective entries of tag repository 122. For example, when the second and third instances of process ID0 eventually complete, the stop time values can be recorded in the tag repository. Depending on the operations in the memory sub-system, it may be possible that additional process instances are initiated in the meantime. Those process instances can be assigned new tags and tracked accordingly.

At operation 330, the processing logic determines a difference between the start time value and the stop time value. For example, the process monitoring component 113 can read the associated entry from tag repository 122 and determine the start time value and the stop time value from that entry. Continuing with the example of the first instance of process ID0 having been assigned tagA, the process monitoring component 113 can read the start time value “342” and the stop time value “349”. The difference between these values (i.e., ‘”7”) represents a total execution time of the instance of the process.

At operation 335, the processing logic exports an indication of the total execution time of the instance of the process from the system via a debugging interface for further analysis. For example, the process monitoring component 113 can send an indication of the total execution time, or in another embodiment send the individual start and stop time values, to a requestor, such as host system 120, or some other debugging system. The debugging interface can include, for example, a peripheral component interconnect express (PCIe) bus, a universal asynchronous receiver-transmitter (UART) bus, a system management bus (SMBus), or some other type of communication mechanism. The host system 120 or debugging system can perform additional analysis on the performance of the memory sub-system 110 using the provided information. For example, the host system 120 or debugging system can calculate any relevant statistics related to the execution time of multiple instances of the process ID including average, median, maximum, minimum, etc. Using these statistics, developers can identify performance bottlenecks in various firmware processing flows in the memory sub-system 110 and optimize such flow across various workloads.

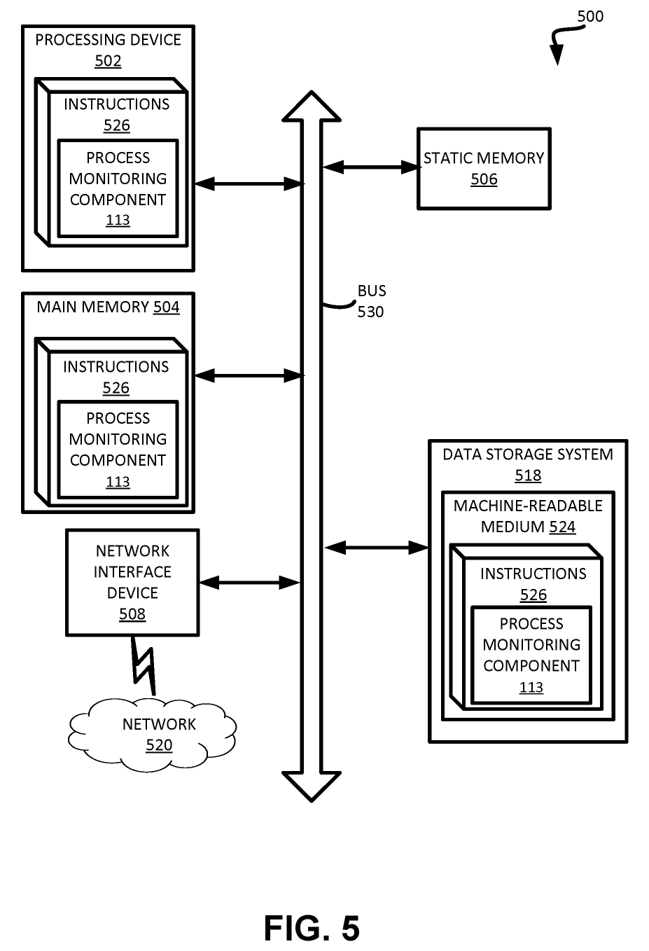

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1 and configured to perform operations corresponding to process monitoring component 113) that includes, is coupled to, or utilizes a memory sub-system (e.g., the memory sub-system 110 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the process monitoring component 113 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a local memory storing a tag repository;
a memory device; and
a processing device, operatively coupled with the local memory and the memory device, to perform operations comprising:
initiating execution of an instance of a process on the memory device;
associating a unique tag with the instance of the process;
storing an indication of a start time value for the instance of the process in an entry of the tag repository corresponding to the unique tag;
detecting a completion of the instance of the process; and
storing an indication of a stop time value for the instance of the process in the entry of the tag repository corresponding to the unique tag.

2. The system of claim 1, wherein the process comprises an asynchronous process where a plurality of instances of the process can be executed in parallel.

3. The system of claim 2, wherein the tag repository comprises respective entries for the plurality of instances of the process.

4. The system of claim 1, wherein the process comprises at least one of a host-initiated memory access operation or an internally-initiated memory sub-system controller process.

5. The system of claim 1, wherein the start time value and the stop time value comprise respective processing cycle counts of the processing device.

6. The system of claim 1, wherein the processing device is to perform operations further comprising:
determining a difference between the start time value and the stop time value, the difference representing a total execution time of the instance of the process.

7. The system of claim 6, wherein the processing device is to perform operations further comprising:
exporting an indication of the total execution time of the instance of the process from the system via a debugging interface for further analysis.

8. A method comprising:
initiating execution of an instance of a process on a memory device;
associating a unique tag with the instance of the process;
storing an indication of a start time value for the instance of the process in an entry of a tag repository corresponding to the unique tag; detecting a completion of the instance of the process; and
storing an indication of a stop time value for the instance of the process in the entry of the tag repository corresponding to the unique tag.

9. The method of claim 8, wherein the process comprises an asynchronous process where a plurality of instances of the process can be executed in parallel.

10. The method of claim 9, wherein the tag repository comprises respective entries for the plurality of instances of the process.

11. The method of claim 8, wherein the process comprises at least one of a host-initiated memory access operation or an internally-initiated memory sub-system controller process.

12. The method of claim 8, wherein the start time value and the stop time value comprise respective processing cycle counts of the processing device.

13. The method of claim 8, further comprising:
determining a difference between the start time value and the stop time value, the difference representing a total execution time of the instance of the process.

14. The method of claim 13, further comprising:
exporting an indication of the total execution time of the instance of the process from the system via a debugging interface for further analysis.

15. A non-transitory computer-readable storage medium comprising instructions that, when executed by a processing device, cause the processing device to perform operations comprising:
initiating execution of an instance of a process on a memory device; associating a unique tag with the instance of the process; storing an indication of a start time value for the instance of the process in an entry of a tag repository corresponding to the unique tag; detecting a completion of the instance of the process; and storing an indication of a stop time value for the instance of the process in the entry of the tag repository corresponding to the unique tag.

16. The non-transitory computer-readable storage medium of claim 15, wherein the process comprises an asynchronous process where a plurality of instances of the process can be executed in parallel.

17. The non-transitory computer-readable storage medium of claim 16, wherein the tag repository comprises respective entries for the plurality of instances of the process.

18. The non-transitory computer-readable storage medium of claim 15, wherein the process comprises at least one of a host-initiated memory access operation or an internally-initiated memory sub-system controller process.

19. The non-transitory computer-readable storage medium of claim 15, wherein the start time value and the stop time value comprise respective processing cycle counts of the processing device.

20. The non-transitory computer-readable storage medium of claim 15, wherein the instructions cause the processing device to perform operations further comprising:
determining a difference between the start time value and the stop time value, the difference representing a total execution time of the instance of the process; and
exporting an indication of the total execution time of the instance of the process from the system via a debugging interface for further analysis.
